(19) United States
(12) Patent Application Publication
(10) Pub. No.: US 2021/0229114 A1
(43) Pub. Date: Jul. 29, 2021

(54) Modular, Adjustable, Multiple Showerhead Assembly

(71) Applicant: Willard Eugene Trefren, Carlisle, PA (US)

(72) Inventor: Willard Eugene Trefren, Carlisle, PA (US)

(21) Appl. No.: 16/752,796

(22) Filed: Jan. 27, 2020

(51) Int. Cl. B05B 1/16; B05B 1/18; E03C 1/04

(52) U.S. Cl. CPC B05B 1/169; E03C 1/025; E03C 1/0408; B05B 1/185

(57) ABSTRACT

The invention is a modular, size adjustable, transferable, customizable shower system that offers a combination of multiple showerheads: two fixed, one fixed and one rainfall, and one rainfall and one handheld type. The invention is size adjustable and transferable because it utilizes an adjustable commercially available shower rod. It is also customizable because also utilizes commercially available showerheads. Both said shower rod and showerheads can be changed out to achieve a different appearance and or effect.

The invention is designed to offer an affordable and attractive alternative to permanently installed systems.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Multiple spray head showering fixture US 4/601, 239/282, 239/281, 211/105.6, 4/615, 239/267, 285/31

Prior art dual-shower-head assemblies that extend between the side walls of a shower/bath enclosure are exemplified in U.S. Pat. Nos.

| | |
|---|---|
| U.S. Pat. No. 1,207,380 (Patrick J Duffy) | U.S. Pat. No. 4,545,083 (Searson Thomas E) |
| U.S. Pat. No. 1,218,879 (August F Luzzi) | U.S. Pat. No. 5,799,346 (Tiernan; Mark R.) |
| U.S. Pat. No. 1,255,396 (John Albert Eaton) | U.S. Pat. No. 5,564,139 (Shorr; Edwin M.) |
| U.S. Pat. No. 2,100,186 (Charles H Hagopian) | U.S. Pat. No. 6,079,060 (Walker; Todd A.) |
| U.S. Pat. No. 2,277,562 (Mathias Schu) | U.S. Pat. No. 6,813,787 (Maury Rosenberg) |
| U.S. Pat. No. 2,336,402 (Albert G Kaiser) | U.S. Pat. No. 7,356,857 (Maury Rosenberg) |
| U.S. Pat. No. 2,540,159 (Antrim Irvin S) | US20100125944 (Theodore Prodzenski) |
| U.S. Pat. No. 3,822,826 (Wilson M) | US20110006134 (Parks Carl D) |
| U.S. Pat. No. 3,913,839 (Wilson Mark L) | US20110010840 (Jeff Paul) |
| U.S. Pat. No. 4,158,896 (Farkas Julius J) | |

Prior art is disadvantageous for several reasons. First, it utilizes non-commercially available parts to span the length of a shower enclosure, which increases overall manufacturing costs and decreases ease of customization. Second, prior art has minimal flexibility in terms of fitting in varying size shower enclosures while utilizing minimal parts, which increases manufacturing costs and decreases the number of shower enclosures a given unit can fit in to. Third, prior art does not focus on customization and or transferability, which limits the number of customers it might appeal to. And fourth, prior art focuses on a fixed, non-modular, design, which decreases both market and production/manufacturing/business appeal because of the increase in variation costs and thus market visibility. Consequently, a need exists for an assembly that utilizes, in part, commercially available parts and is characterized by having installment flexibility, customization options, and low variation costs.

The invention described herein fulfills these needs by utilizing a commercially available adjustable/extension shower-curtain rod that has limited mechanics. Said shower rod is utilized in such a way that it is easily replaced by another, of a different finish, for example, in order to customize the invention. The assembly has a limited number of simple steps that are required to install and or transfer it from one enclosure to another. Furthermore, the invention is modular and utilizes a limited number of parts in different quantities and combinations to cost effectively create various water spray angles and or patterns.

### BRIEF SUMMARY OF THE INVENTION

The invention is a multi-showerhead modular assembly that utilizes a commercially available extension/tension shower-curtain rod to hang from. Said shower rod and the installed showerheads can be easily swapped out for customization purposes. The invention requires only a limited number of simple steps to install and transfer and it is modular in design meaning that it allows for the creation of various water spray angles and or patterns by utilizing a limited number of parts.

### BRIEF DESCRIPTION OF THE SEVERAL VIEWS OF THE DRAWING

FIG. 1 Preferred, Preferred Embodiment of Assembly Installed in a Shower Enclosure

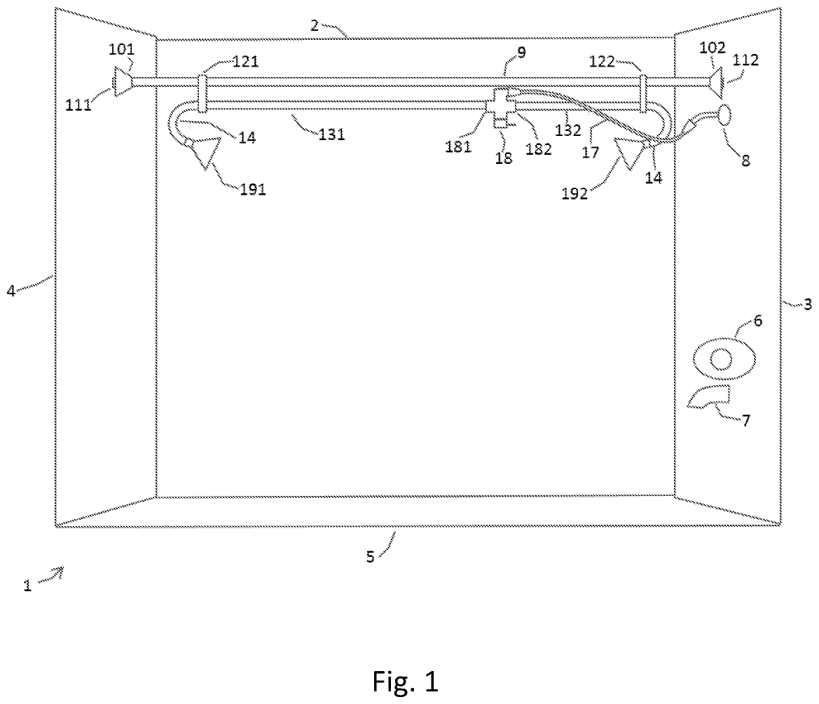

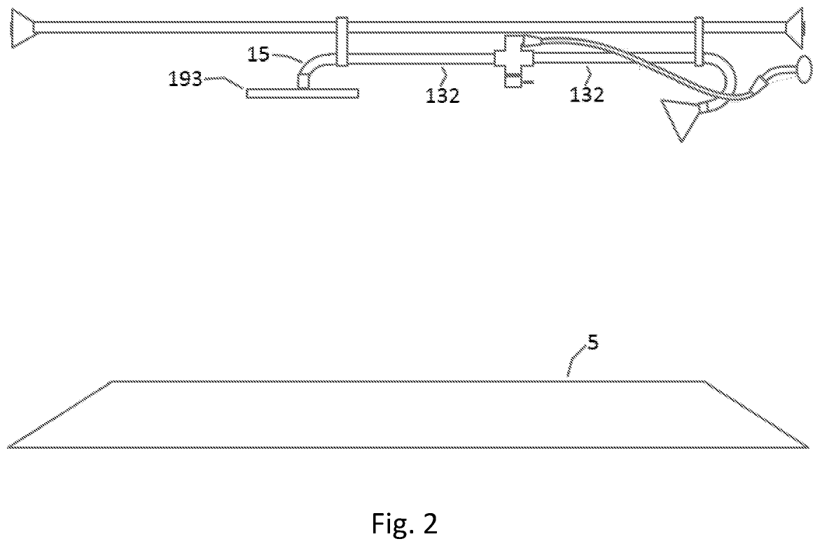

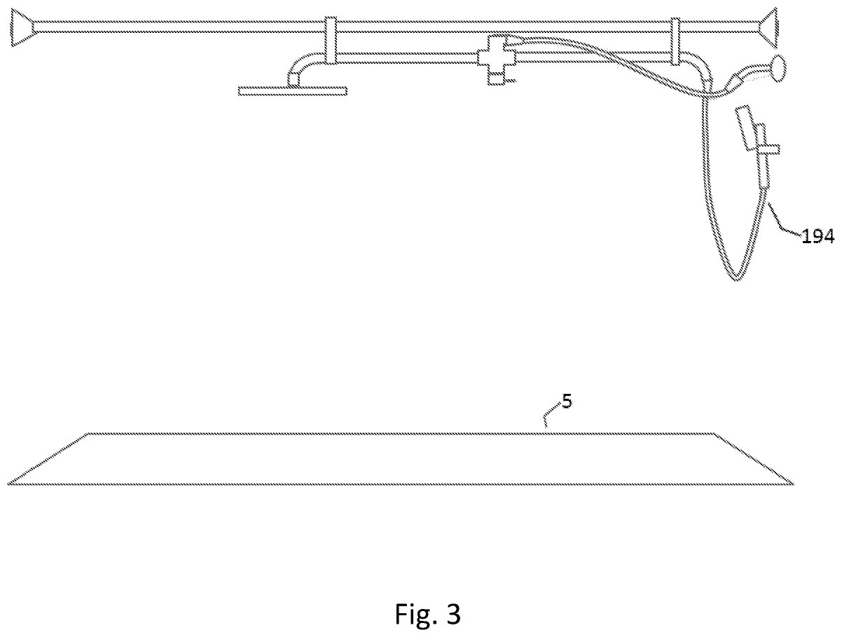

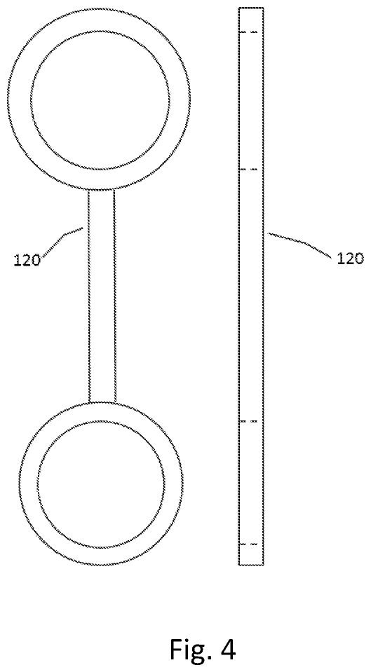

Depicted is the invention/assembly installed in a shower enclosure/tub alcove/enclosure [010]; a side/back wall [020]; a head/front wall [030]; a foot/rear wall [040]; an enclosure floor [050]; a tub/shower valve and a flange [060]; a tub spout [070]; and a shower arm [080]. A means for keeping water within said enclosure [010] is not shown for invention illustration clarity.

Said assembly is hung from a commercially available adjustable/extension/tension/shower-curtain rod [090] that keeps the assembly, in its entirety suspended overhead, oriented essentially parallel to said floor [050], and straddling the length of said enclosure [010]. Preferably said shower-curtain rod [090] utilizes a foot [101, 102], a boot [111, 112], and a tension element (not shown) to keep it in place (e.g. Moen model TR1000). Alternatively, said shower-curtain rod [090] uses screws or nails to anchor it in place (e.g. Zenith model 648WW).

A hanging bracket [120] is used to hang both a inch diameter, 27 inch long water conduit [131] and a inch diameter, 13 inch long water conduit [132] from said shower-curtain rod [090]. Said bracket [120] is preferably formed out of a single piece of material suitable for or treated to be suitable for plumbing applications/damp environments.

Preferably, the main body of said 27 inch long water conduit [131] and said 13 inch long water conduit [132] has a circular cross section. Alternatively, the cross section is rectangular to enhance appearance and or stability of the assembly.

One end of a flexible inch Female Compression Thread (FCT) supply line [170] is directly connected to a shower arm [080]. The other/opposite end said supply line [170] is directly connected to a valve [180] that can direct fluid in a multitude of directions. Subsequently there is a fluid connection between said arm [080] and said valve [180].

Directly connected, to a left port [181] and a right port [182] of said valve [180] are said 27 inch long water conduit [131] and said 13 inch long water conduit [132] respectively. Relating to said 27 inch long water conduit [131] and said 13 inch long water conduit [132] the end opposite of said left port [181] and said right port [182] connection is a 135 degree fitting [140, 140] that has attached a commercially available, high efficiency showerhead [191, 192] respectively.

FIG. 2 Preferred, Alternative Embodiment of Assembly with Rainfall Showerhead

Similar to the Preferred, Preferred embodiment, this embodiment, utilizes a shower-curtain rod [090], a bracket [120], a supply line [170], and a valve [180] in the same way and for the same functions.

Directly connected to a left port [181] of said valve [180] is a 1/2 inch diameter, 13 inch long water conduit [132] Relating to said 13 inch long conduit [132] the end opposite of said left port [181] connection is directly connected a 90 degree fitting [150] that has attached a commercially available rainfall showerhead [193] (e.g. Niagara Conservation model: RN9520CH).

Directly connected to a right port [182] of said valve [180] is a 1/2 inch diameter, 13 inch long water conduit [132]. Relating to said 13 inch long conduit [132] the end opposite of said right port [182] connection is directly connected a 135 degree fitting [140] that has attached a commercially available, high efficiency showerhead [192].

The preferred distance between said rainfall showerhead [193] and said showerhead [192] is 20 to 35 inches and in the actual embodiment is approximately 29 inches.

FIG. 3 Alternative, Alternative Embodiment of Assembly with Handheld Showerhead

Similar to the Preferred, Preferred embodiment, this embodiment, utilizes a shower-curtain rod [090], a bracket [120], a supply line [170], a valve [181], and a rainfall showerhead [193] in the same way and for the same functions. Moreover, a right port [182] of said valve [180] is set up similarly and for the same purpose as described in the Preferred, Alternative embodiment.

Directly connected to said right port [182] of said valve [180] is a 1/2 inch diameter, 13 inch long water conduit [132]. Relating to said 13 inch long conduit [132], the end opposite of said right port [182] connection is a commercially available handheld type showerhead with wall mount assembly [194] (e.g. Moen 3865Ep Showering Accessories-Basic Handheld Shower).

The preferred distance between said rainfall showerhead [193] and said handheld type showerhead [194], when secured, is 20 to 35 inches and in the actual embodiment is approximately 29 inches.

While cited models are acceptable, and indeed preferable, it should be noted that a variety of other shower-curtain rods, valves, and showerheads can be used in the present invention. Moreover, while particular embodiments of the invention have been recommended; it will be obvious to those in the art that changes and modifications may be made without departing from the design and functionality of the invention. Therefore, the aim in the appended claims is to cover all such changes and modifications as fall within the true spirit and scope of the invention.

FIG. 4 Hanging Bracket: Face and Side

Illustrated is the preferred embodiment a hanging bracket [120] by which the parts directly related to a method to direct water flow hang from a shower-curtain rod [090]. I.e. a valve [180], a 27 inch long water conduit [131], a 13 inch long water conduit [132], a showerhead [191, 192], a rainfall showerhead [193] and or a handheld type showerhead [194]

The main circular openings/opening diameters of the bracket [120] are of the size to allow said parts directly related to water flow to substantially be horizontally aligned with said shower-curtain rod [090].

Preferably said bracket [120] is made of a single piece of material such as polyvinyl chloride or other material suitable for, or treated to be made suitable for, a shower/damp environment (e.g. brass or an epoxy covered metal).

### COMPONENT NUMERALS

010 = shower enclosure/tub alcove/
enclosure
020 = side/back wall
030 = head/front wall
040 = foot/rear wall
050 = enclosure floor
060 = tub/shower valve and flange
070 = tub spout
080 = shower arm
090 = commercially available
adjustable/extension/tension/shower-
curtain rod
101, 102 = foot
111, 112 = boot
120 = hanging bracket
131 = ½″ dia, 27″ long water conduit
132 = ½″ dia, 13″ long water conduit
140 = ½″ 135 degree fitting
150 = ½″ 90 degree fitting
170 = ½″ flexible Female Compression
Thread (FCT) supply line
180 = valve that can direct fluid in
multitude of directions
181 = left port
182 = right port
191, 192 = commercially available, high
efficiency showerhead
193 = commercially available rainfall
showerhead
194 = commercially available handheld
type showerhead with wall mount
assembly

### DETAILED DESCRIPTION OF THE INVENTION

How the Components Connect

Connections: Preferred, Preferred Embodiment of Assembly

A shower arm [080] is directly connected, via a treaded connection, to one end of a inch flexible Female Compression Thread (FTC) supply line [170]. The other/opposite end of said supply line [170] is directly connected, via a treaded connection, to a valve [180] that can direct fluid in multiple directions.

A 1/2 inch diameter, 27 inch long water conduit [131] threads into a left port [181] of said valve [180]. The opposite end of said 27 inch long water conduit [131] threads into a inch 135 degree fitting [140]. The opposite end of said 135 degree fitting [140] is threaded into a commercially available, high efficiency showerhead [191]. Consequently, a fluid connection is created between said valve [180], said 27 inch long water conduit [131], said 135 degree fitting [140], and said showerhead [191].

A 1/2 inch diameter, 13 inch long water conduit [132] threads into a right port [182] of said valve [180]. The opposite end of said 13 inch long water conduit [132] threads into a inch 135 degree fitting [140]. The opposite end of said 135 degree fitting [140] is threaded into a commercially available, high efficiency showerhead [192]. Consequently, a fluid connection is created between said valve [180], said 13 inch long water conduit [132], said 135 degree fitting [140], and said showerhead [191].

Both said 27 inch long water conduit [131] and 13 inch long water conduit [132] go through one of two circular opening/opening diameter, of a hanging bracket [120, 120] so that said 27 inch long water conduit [131] and said 13 inch long water conduit [132] and said bracket [120, 120] are connected. A commercially available adjustable/extension/tension/shower-curtain rod [090] goes through the other/opposite main circular opening of said bracket [120, 120] so that said shower-curtain rod [090] and said bracket [120, 120] are also connected.

Connections: Preferred, Alternative Embodiment of Assembly

A shower arm [080] is directly connected, via a treaded connection, to one end of a inch flexible Female Compression Thread (FTC) supply line [170]. The other/opposite end of said supply line [170] is directly connected, via a treaded connection, to a valve [180] that can direct fluid in a multitude of directions.

A 1/2 inch diameter, 13 inch long water conduit [132] threads into a left port [181] of said valve [180]. The opposite end of said 13 inch long water conduit [132] threads into a inch 90 degree fitting [150]. The opposite end of said 90 degree fitting [150] is threaded into a commercially available rainfall showerhead [193]. Consequently, a fluid connection is created between said valves [180], said 13 inch long water conduit [132], said 90 degree fitting [150], and said rainfall showerhead [193].

A 1/2 inch diameter, 13 inch long water conduit [132] threads into a right port [182] of said valve [180]. The opposite end of said 13 inch long water conduit [132] threads into a inch 135 degree fitting [140]. The opposite end of said 135 degree fitting [140] is threaded into a commercially available, high efficiency showerhead [192]. Consequently, a fluid connection is created between said valve [180], said 13 inch long water conduit [132], said 135 degree fitting [140], and said showerhead [192].

Both said 13 inch long water conduit [132] and 13 inch long water conduit [132] go through one of two circular opening/opening diameter, of a hanging bracket [120, 120] so that said 13 inch long water conduit [132] and said 13 inch long water conduit [132] and said bracket [120, 120] are connected. A commercially available adjustable/extension/tension/shower-curtain rod [090] goes through the other/opposite main circular opening of said bracket [120, 120] so that said shower-curtain rod [090] and said bracket [120, 120] are also connected.

Connections: Alternative, Alternative Embodiment of Assembly

A shower arm [080] is directly connected, via a treaded connection, to one end of a inch flexible Female Compression Thread (FTC) supply line [170]. The other/opposite end of said supply line [170] is directly connected, via a treaded connection, to a valve [180] that can direct fluid in multitude of directions.

A 1/2 inch diameter, 13 inch long water conduit [132] threads into a left port [181] of said valve [180]. The opposite end of said 13 inch long water conduit [132] threads into a inch 90 degree fitting [150]. The opposite end of said 90 degree fitting [150] is threaded into a commercially available rainfall showerhead [193]. Consequently, a fluid connection is created between said valve [180], said 13 inch long water conduit [132], said 90 degree fitting [150], and said rainfall showerhead [193].

A 1/2 inch diameter, 13 inch long water conduit [132] threads into a right port [182] of said valve [180]. The opposite end of said 13 inch long water conduit [132] threads into a inch 90 degree fitting [150]. The opposite end of said 90 degree fitting [150] is threaded into a commercially available handheld type showerhead with wall mount assembly [194]. Consequently, a fluid connection is created between said valve [180], 13 inch long water conduit [132], said 90 degree fitting [150], and said handheld type showerhead [194].

Both said 13 inch long water conduit [132] and 13 inch long water conduit [132] go through one of two circular opening/opening diameter, of a hanging bracket [120, 120] so that said 13 inch long water conduit [132] and said 13 inch long water conduit [132] and said bracket [120, 120] are connected. A commercially available adjustable/extension/tension/shower-curtain rod [090] goes through the other/opposite main circular opening of said bracket [120, 120] so that said shower-curtain rod [090] and said bracket [120, 120] are also connected.

In each embodiment of the assembly a commercially available shower-curtain rod [090] is connected to a head/front wall [030] and a foot/rear wall [040] of a shower enclosure [010] by tension as commercial intended. Also, preferably all treaded connections utilize a sealant medium such as Teflon tape to help ensure the connection is watertight.

While particular operations of the preferred, alternative, and variety versions of the invention has been described, it will be obvious to those in the art that changes and modifications may be made without departing from the invention. Therefore, the aim in the appended claims is to cover all such changes and modifications as fall within the true spirit and scope of the invention.

Operation

Operation of Preferred, Preferred Embodiment of Assembly

Once the assembly is installed in a shower enclosure [010], open/start the flow of water by opening/turning the valve of a tub/shower valve and flange [060]. Next, adjust/turn the handle of a valve [180] that can direct fluid in multitude of so that water flows to a commercially available, high efficiency showerhead [191] and or a commercially available, high efficiency showerhead [192].

A water spray angle adjustment is achieved by adjusting the direction/angle of the showerhead ball joint (a standard feature of commercially available showerheads) of said showerhead [191, 192]. A secondary way to adjust the water spray angle, not to preclude the first, is to adjust the flow/pressure/rate of water by further opening or closing the valve of a tub/shower valve and flange [060].

Operation of Preferred, Alternative Embodiment of Assembly

Once the assembly is installed in a shower enclosure [010], open/start the flow of water by opening/turning the valve of a tub/shower valve and flange [060]. Next, adjust/turn the handle of a valve [180] that can direct fluid in multitude of directions so that water flows to a commercially available, high efficiency rainfall showerhead [193] and or a commercially available, high efficiency showerhead [192].

A water spray angle adjustment is achieved by adjusting the direction/angle of the showerhead ball joint (a standard feature of commercially available showerheads) of said showerhead [193, 192]. A secondary way to adjust the water spray angle, not to preclude the first, is to adjust the flow/pressure/rate of water by further opening or closing the valve of a tub/shower valve and flange [060].

Operation of Alternative, Alternative Embodiment of Assembly

Once the assembly is installed in a shower enclosure [010], open/start the flow of water by opening/turning the valve of a tub/shower valve and flange [060]. Next, adjust/turn the handle of a valve [180] that can direct fluid in multitude of so that water flows to a commercially available handled type showerhead with wall mount assembly [194] and or a commercially available, high efficiency showerhead [191].

A water spray angle adjustment is achieved by adjusting the direction/angle of the showerhead ball joint (a standard feature of commercially available showerheads) of said showerhead [191] and/or unsecure and point said handheld type showerhead [194] in the desired direction. A secondary way to adjust the water spray angle, not to preclude the first, is to adjust the flow/pressure/rate of water by further opening or closing the valve of a tub/shower valve and flange [060].

Alternative Uses

Said adjustable multiple-showerhead assembly as described, herein, in length, can, in addition to its primary purpose, alternatively be used as is or variation thereof for any of the following uses:

Washing apparatus/station for an elderly, infirm, handicap, and or any person with low or strained physical-maneuverability

Hydrotherapy

Pet washing apparatus/station

To intermittently or continually cool/chill multiple sides of an item, fluid, or body

To intermittently continually warm/heat multiple sides of an item, fluid, or body

1. An adjustable multiple showerhead modular assembly comprising:
a rigid elongate member having opposite ends and an adjustable longitudinal axis extending between said ends wherein said elongate member is essentially adjusted to the length of an enclosure and essentially mounted overhead a number of user within said enclosure;
a number of bracket attach to said elongate member at spaced locations to support a number of valve, conduit, and showerhead;
whereby said number of valve, conduit, and showerhead are used in combination for directing fluid onto a number of user within said enclosure;

2. The shower fixture of claim 1, wherein a flexible conduit connects a spigot within said enclosure to said valve;

3. The shower fixture of claim 1, wherein interchangeable conduit are used in various combinations whereby various angles and or patterns of water spray are created.
